(19) United States
(12) Patent Application Publication
(10) Pub. No.: US 2013/0162951 A1
(43) Pub. Date: Jun. 27, 2013

(54) Animation Apparatus

(71) Applicant: Ryan Carter Buyssens, Charlotte, NC (US)

(72) Inventor: Ryan Carter Buyssens, Charlotte, NC (US)

(21) Appl. No.: 13/680,238

(22) Filed: Nov. 19, 2012

Related U.S. Application Data
(60) Provisional application No. 61/630,910, filed on Dec. 22, 2011.

(51) Int. Cl. G03B 25/00

(52) U.S. Cl. CPC G03B 25/00
USPC 352/102

(57) ABSTRACT

Animation apparatus and methods wherein two- or three-dimensional individual animation items are carried by a support movable incrementally through an endless path composed of a plurality of segments or sections of uniform length. The number of animation items may be the same as, or more or less than, the number of incremental segments of such path. The frequency of movement and the speed of such movement during each segment, and the dwell period between successive segments, are such as to produce animation of the items via the persistence of vision phenomenon.

### BACKGROUND OF THE INVENTION

One of the earliest animation devices is the hand-rotated Phenakistoscope (by J. Plateau, ca. 1832) employing a rotary disk with radial viewing slits arranged to create a shutter-like effect on a series of images applied to the reverse side of the disk. With the image side of the disk facing a mirror, the disk is rotated. By viewing through the slits the images reflected by the mirror the illusion of motion or animation is achieved. This device can only be viewed by one person and the animations are dark and difficult to see clearly, due to the shutter-like effect of the slits.

An improvement of the Plateau design was the Zoetrope (by W. Homer, ca. 1834) which employs a manually rotatable cylindrical drum in which the top edge of the drum has vertical viewing slits for viewing sequential images carried by the interior of the drum. As the drum rotates, the slits create the same shutter-like effect animation. The animation can be viewed by more than one person, but the visible quality of the animation is little improved over the Plateau device.

Some years after the introduction of the Zoetrope design, E. Muybirdge substituted three-dimensional objects for the two-dimensional images proposed by Homer.

The Praxinoscope (proposed by E. Reynaud, ca. 1877) eliminated the need for viewing slits by employing a set of radially facing mirrors positioned in the center of either a hand rotated disk or cylinder to reflect the images toward the viewer. The animation could be viewed simultaneously by multiple persons and is bright. Certain distortions and restricted angles of view adversely affected this design.

All of the previously mentioned devices originally were hand rotated utilizing an uninterrupted, decaying rate of rotation. Later variations employed motors to obtain consistent rotational speed. An apparatus patented in 1999 by O. Pope utilizes a motor to rotate a disk at a continuous speed. Applied to the disk are three-dimensional objects that are illuminated by a pulsing strobe light source which creates an animation effect. Unobstructed open view is achieved, but with the disadvantage of having to use a strobe light source which can be difficult to see in certain lighting conditions and may adversely affect its viewers.

An object of the invention is to provide animation apparatus and methods for providing real time animation of inanimate objects and images without the necessity of viewing slits, shutters, mirrors, or specialized light sources.

### SUMMARY OF THE INVENTION

In the present invention the animation content is carried on the surface of a support that moves along an endless path in increments of uniform length. The content is sequential in nature and the effect of the intermittent movement creates the simulation of motion via the phenomenon of persistence of vision. The apparatus enables the animation content to be viewed without physical obstruction and without reliance on specialized lighting. Without limitations of viewing slits, and mirrors the content may be animated within three dimensions. Without the limitations of strobe or other special lighting, the content may be illuminated in any desired way. If the user desires, the content may be removed, rearranged, and replaced.

### THE DRAWINGS

FIG. 1 is a diagrammatic, perspective view of one embodiment of the invention;

FIG. 2 is a diagrammatic, perspective view of a modified embodiment;

### DETAILED DESCRIPTION

In all of the disclosed embodiments of the invention the animation content comprises a sequence of inanimate three-dimensional objects or two-dimensional images arranged in spaced apart relation on a carrier or support for movement along an endless path. In the following description and claims the collection of dimensional objects and images shall be referred to as animation content, whereas a single object or image shall be referred to as an animation content item.

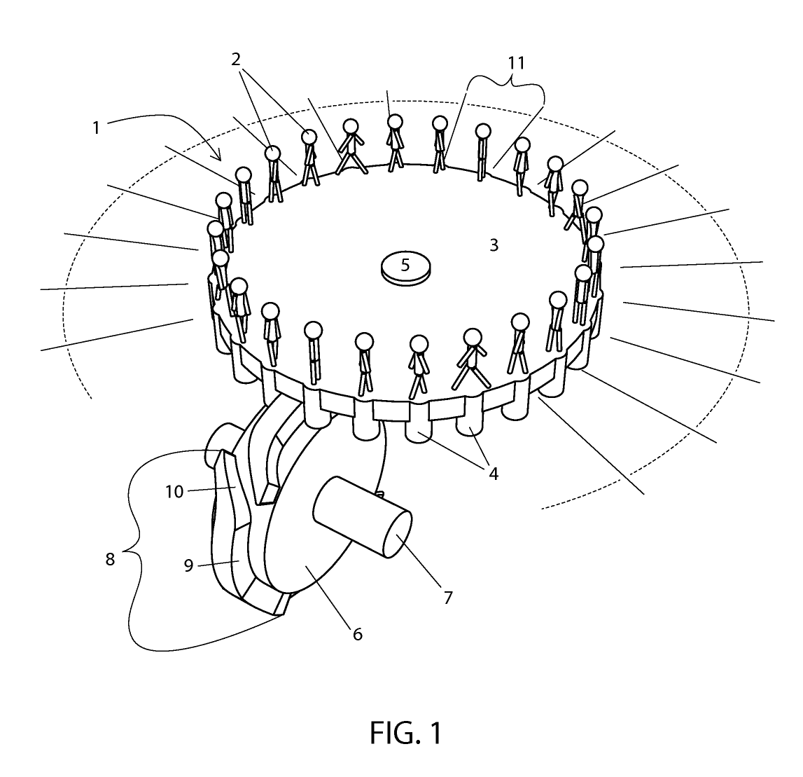

The embodiment shown in FIG. 1 comprises animation content 1 composed of a plurality of three-dimensional content items 2 arranged in uniformly spaced apart relation on a disk 3. The disk 3 being coupled to a cylindrical spindle 5 journaled in a base (not shown) and having peripheral, uniformly spaced, cam followers 4 mounted parallel to the axis of the spindle 5. Adjacent the disk 3 is a cylindrical cam drive assembly 6 coupled by a spindle 7 to a continuously rotating, known motor or hand crank (not shown). The axis of rotation of the cam drive assembly 6 is perpendicular to the axis of rotation of the disk 3. Fixed to the periphery of the cylindrical cam drive assembly 6 is a cam lobe 8 having a portion of its edge surface straight, smooth and uninterrupted 9. However, the cam lobe has an angled clearance 10 in a portion of the edge surface that confronts the cam followers 4. In the following description and claims, the straight, smooth and uninterrupted edge surface 9 shall be further referred to as dwell surface and the angled clearance 10 shall be referred to as index surface.

In the operation of the embodiment, the continuously operable motor or hand crank is actuated to rotate the cam assembly 6 continuously so that the index surface 10 periodically will engage a cam follower 4 of the disk 3 and index the disk in successive, uniform increments in an endless path, and then disengage the cam follower 4. Once the index surface disengages the cam follower 4, the dwell surface 9 of the cam 6 will engage the surfaces of two adjacent cam followers 4 and maintain the disk 3 in a fixed, non-rotating position until such time as the index surface 10 is rotated through a distance sufficient to engage another cam follower 4. The indexing of the disk 3 divides it into a plurality of arcuate segments 11 and each content item 2 occupies the center of a segment 11. Each segment is of uniform dimensions. Rotation of the disk 3 forms an endless path of movement for the items 2 and each increment of movement corresponds to the circumferential length of each segment 11. The intermittent starting and stopping, or frequency, of the rotation of the ring is repetitive. The length and speed of each incremental movement and of each dwell period between successive rotary increments are uniform and such as to enable the achievement of the phenomenon of persistence of vision.

In this example, each illustrative content item 2 is a three-dimensional representation of a person having a head, a body, two arms, and two legs. Although each item is similar, the positions of the arms and legs of each figure are sequentially different for the purpose of providing an animation that presents the illusion during intermittent rotation of the ring that the person represented by the item is walking.

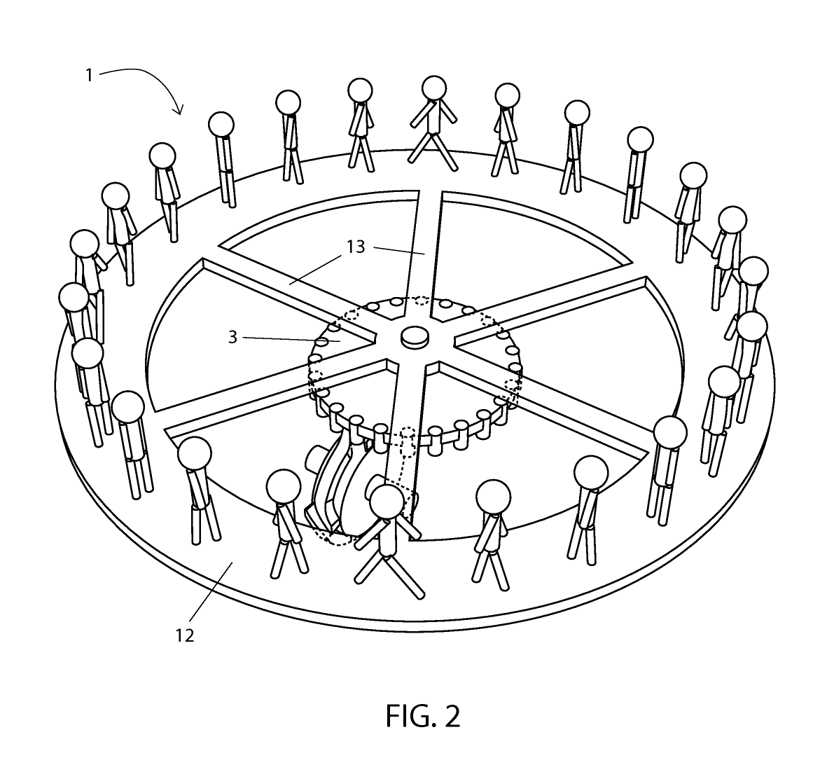

The modified embodiment shown in FIG. 2 has an identical mechanism as in FIG. 1 except that the animation content 1 is attached to a secondary surface that is fixed to the toothed disk 3. In this example the secondary surface is a ring 12 having spokes 13 connecting the ring to the toothed disk 3. This modification allows for a smaller mechanism while, comparatively, having larger content 1 for animation. The secondary surface may also be in the form of a disk, cylinder, cone, frustum or other axially symmetric shape.

The disclosed embodiments are representative of presently preferred forms of the invention, but are intended to be illustrative rather than definitive thereof. The invention is defined in the claims.

I claim:

1. Automation apparatus comprising a movable support; a plurality of animation items carried by said support and together constituting animation content, said items being spaced apart from one another; and means for moving said support along an endless path in a plurality of segments, said automation items being sufficiently different from one another that the movement of said support at such frequency that the phenomenon of persistence of vision produces the effect of animation of said content, the spacing between said items, the length of each segment of movement, and the speed of movement of said support being such as to produce the appearance of animation of said animation content.

2. The apparatus according to claim 1 wherein said means for moving said support comprises an intermittently operable drive mechanism.

3. The apparatus according to claim 2 wherein the intermittently operable drive mechanism comprises a cylindrical cam.
